(19) United States
(12) Patent Application Publication
(10) Pub. No.: US 2012/0161432 A1
(43) Pub. Date: Jun. 28, 2012

(54) PNEUMATIC CONNECTOR DEVICE

(75) Inventors: James Nyal Mashak, Madison, WI (US); Mark Edward Woelfel, Totowa, NJ (US); Paul Andrew Kendrick, Totowa, NJ (US)

(73) Assignee: GENERAL ELECTRIC COMPANY, Schenectady, NY (US)

(21) Appl. No.: 12/976,480

(22) Filed: Dec. 22, 2010

(51) Int. Cl. F16L 41/00

(52) U.S. Cl. 285/122.1

(57) ABSTRACT

A connector device to attach a pneumatic circuit tube to a first and second end fitting of a pneumatic system is provided. The device comprises a first connecting structure that positively attaches to pneumatic circuit tube to the first end fitting of the pneumatic system, and a second connecting structure that positively attaches to the pneumatic circuit tube to the second end fitting of the pneumatic system. A pull arm connects between the first connecting structure to the second connecting structure, and transmits a single application of force on the pull arm to release both the first connecting structure from attachment at the first end fitting and the second connecting structure from attachment at the second end fitting.

This invention generally relates to a pneumatic connector device to connect a pneumatic circuit tube to a pair of end fittings of a pneumatic system, and more particularly to a pneumatic connector device to disconnect a dual pneumatic tubes connecting a patient interface via a breathing circuit tube to a pneumatic system such as a ventilator or respirator or the like.

### BACKGROUND

Medical equipment typically includes various types of hoses and tubes for transmitting gases. For example, anesthesia and respiratory care typically uses pneumatic circuit tubes to supply oxygen and/or anesthesia from the ventilating apparatus (machine) to a patient (e.g., mask). The tubes can typically include an inspiratory tube and an expiratory tube for positive connection to the pneumatic system. Each tube is known to positively attach to the ventilating machine via utilizing male and female taper adapters, controlled by industry standards. Typically the female adapters include a taper for positive connection to a taper at the male adapters at the pneumatic system. Typical female and male adapters also are known to have a groove at the rear of each taper.

Drawbacks of known connections of the tubes to the pneumatic system include increased likelihood of disconnection if the taper at the female adapter of the tube is not fitted tightly to the taper at the male adapter at the pneumatic system, which is dependent on the force used to push the female and male adapter tapers together. A Disconnection can disrupt the supply of breathing air, anesthesia or other gases to the patient or other desired manner. Another known drawback of pneumatic system is the cumbersome multiple connections of tubes to be made at the pneumatic system. The hoses or tubes may need to be routinely connected and disconnected for cleaning and/or disposal.

### BRIEF DESCRIPTION

The above-mentioned shortcomings, disadvantages and problems are addressed by the embodiments described herein in the following description of a method and device to attach multiple medical hoses to a medical machine. In one example, an advantage of the dual connector apparatus provides for a need for ready connection of the circuit tubes between the patient and a ventilating apparatus. Operators desire a dual connector apparatus to be inexpensive, compatible with industry standards, and provide a reliable positive connection and ready disconnection of the hoses or tubes for cleaning or disposal.

In one embodiment of the subject matter described herein, a connector device to attach a pneumatic circuit tube to a first and second end fitting of a pneumatic system is provided. The device comprises a first connecting structure that positively attaches to pneumatic circuit tube to the first end fitting of the pneumatic system, and a second connecting structure that positively attaches to the pneumatic circuit tube to the second end fitting of the pneumatic system. A pull arm connects between the first connecting structure to the second connecting structure, and transmits a single application of force on the pull arm to release both the first connecting structure from attachment at the first end fitting and the second connecting structure from attachment at the second end fitting.

In another embodiment of the subject matter described herein, a connector device to connect a pneumatic circuit tube between a patient interface and a pneumatic system is provided. The device comprises a manifold including a first tube and second tube that interconnects the pneumatic circuit tube to the first and second end fittings of the pneumatic system, and a dual connector apparatus that includes a first connecting structure and a second connecting structure. The first connecting structure positively attaches the first tube at the first end fitting of the pneumatic system and the second connecting structure positively attaches the second tube at the second end fitting. The dual connector further includes a pull arm that interconnects the first and second connecting structures, such that an application of force on the pull arm causes both release of the first and second connecting structures from positive attachment at the first and second end fittings of the pneumatic system.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an isometric view of a first embodiment of a pneumatic connector device interconnecting a pneumatic system with a pneumatic circuit tube leading to a patient interface, in accordance with the subject matter described herein.

FIG. 2 shows a schematic diagram of a top view of an embodiment of the pneumatic connector device in combination with a pneumatic system of FIG. 1, in accordance with the subject matter described herein.

FIG. 3 illustrates a schematic diagram a cross-section view of an embodiment of the pneumatic connector device along line 3-3 in FIG. 1 in accordance with the subject matter described herein.

FIG. 4 shows a schematic diagram of an isometric view of a second embodiment of a pneumatic connector device in combination with a pneumatic system in accordance to the subject matter described herein.

### DETAILED DESRIPTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

In this document, the terms “a” or “an” are used, to include one or more than one. In this document, the term “or” is used to refer to a nonexclusive or, unless otherwise indicated.

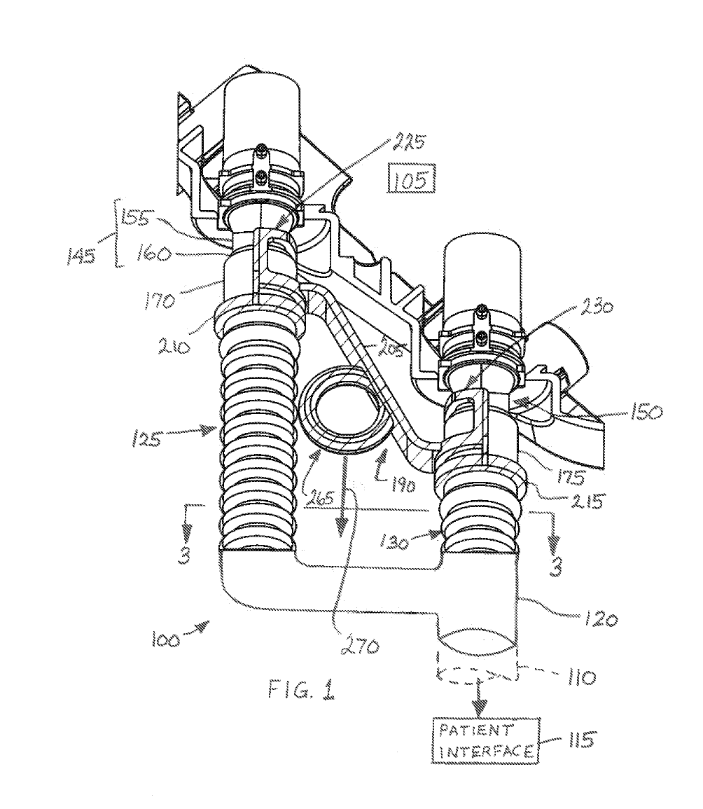

FIGS. 1 through 3 illustrates an embodiment of pneumatic connector device 100 in accordance to the subject matter described herein to interconnect a pneumatic or ventilation system 105 to a pneumatic circuit tube or hose 110 leading to a patient interface 115. One embodiment of the pneumatic connector device 100 can comprise a manifold 120 that includes a first branch tube 125 and a second branch tube 130 that connects the pneumatic circuit tube 110 and patient interface 115 to the pneumatic system 105.

In one example, the pneumatic circuit tube or hose 110 can include a single tube, dual lumen circuit type (e.g., LIMB-O™) associated with delivery of breathing fluids (e.g., air, anesthesia, oxygen, etc.) and removal of exhaled fluids from the patient interface 115. In such example, the pneumatic connector device 100 can include a manifold connecting structure to the pneumatic circuit tube 110 such that the first branch tube 125 of the pneumatic connector device 100 can communicate fluids associated with the expiratory breathing process and the second branch tube 130 can communicate fluids associated with the inspiratory breathing process. The first and second branch tubes 125, 130 of the pneumatic connector device 100 can each further include female type end fittings (discussed below) that interconnect the pneumatic circuit tube 110 to the pneumatic system 105.

The embodiment of the pneumatic system 105 can include any machine that supports communication of fluids (etc., air, oxygen, nitrogen, carbon dioxide, anesthesia, etc.) associated with respiration or ventilation of the patient (not shown). Examples of the pneumatic system 105 can include APOLLO™ anesthesia workstation by DRAGER™ Medical, Inc.

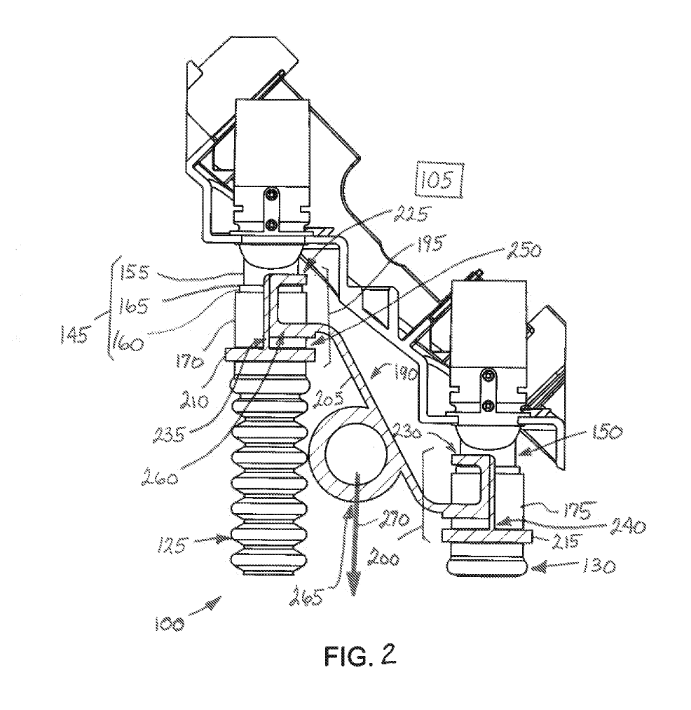

The pneumatic system 105 can include first and second end fittings 145, 150 to communicate fluids to and from the pneumatic circuit tube 110 in combination with the patient interface 115. An embodiment of the first end fitting 145 can be configured to receive the expiratory fluids via the first branch tube 125 of the manifold 120, and the second end fitting 150 can be configured to receive the inspiratory fluids via the second branch tube 130 of the manifold 120. Each pneumatic system end fitting 145, 150 can include a reduced diameter portion 155 extending outward from the machine 105, and an enlarged diameter portion 160 extending further outward from the reduced diameter portion 155, defining a shoulder 165 (See FIG. 2) therebetween where the reduced and enlarged diameter portions 155, 160, respectfully abut one another. An embodiment of each pneumatic system end fitting 145, 150 can be a male type according to an industry standard configured to receive the pneumatic connector device 100, and each end fitting 145, 150 can be staggered in alignment relative to one another in extending from the pneumatic system 105.

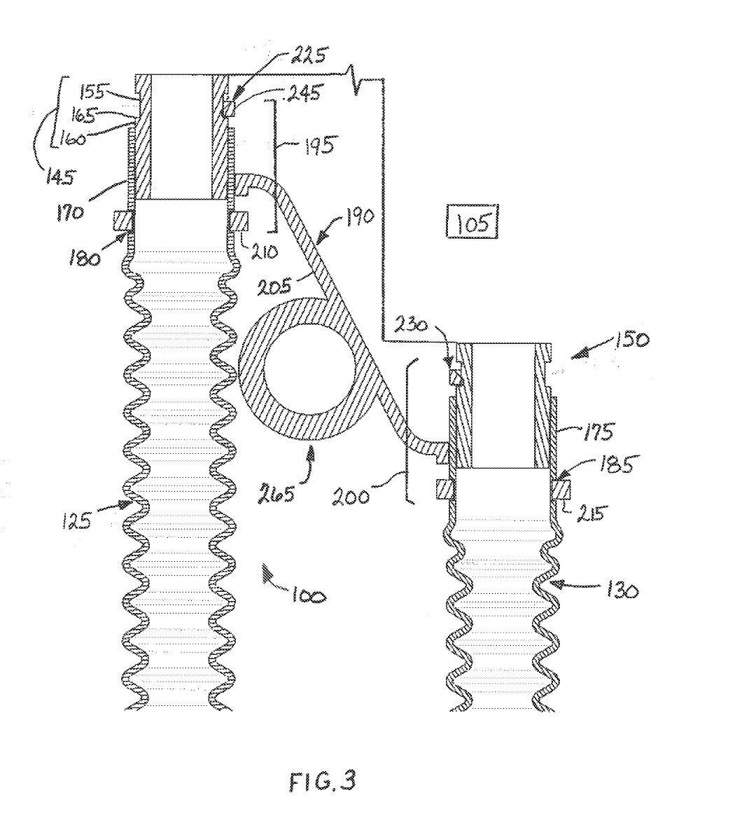

The first and second branch tubes 125, 130 of the manifold 120 can each include an end fitting 170, 175 that is a female type according to an industry standard, one of which includes a 22m rubber or plastic connecting structure, configured to receive the respective male type end fitting of the pneumatic system 105. The end fittings 170, 175 of the first and second branch tubes 125, 130 of the manifold 120 can further include a circular or annular groove 180, 185 (See FIG. 3) or recess of standard dimensions.

An embodiment of the pneumatic connector device 100 can further include a dual connector apparatus 190 (illustrated in cross-hatching in FIGS. 1 and 2) generally configured to connect and provide for ready disconnection or removal of the expiratory and inspiratory branch tubes 125, 130 from the end fittings 145, 150 at the pneumatic system 105. One embodiment of the dual connector apparatus 190 can be a unitary, plastic injection molded part (e.g., polysulfone) that is steam autoclavable or single-use (e.g., nylon) and capable to being displaced with material memory or bias to return to the original position. The dual connector apparatus 190 can be capable of being removed independent of the manifold 120, or removed in combination with the manifold 120.

Referring to FIGS. 2 and 3, the dual connector apparatus 190 can includes a first connecting structure 195 opposite from a second connecting structure 200, with a pull arm 205 interconnected therebetween. The first connecting structure 195 can be configured to positively attach the end fitting 170 of the first expiratory branch tube 125 of the manifold 120 of the pneumatic connector device 100 to the respective expiratory end fitting 145 of the pneumatic system 105. In a like manner, the second connecting structure 200 can be configured to positively attach the end fitting 175 of the inspiratory branch tube 130 of the manifold 120 of the pneumatic connector device 100 to the respective inspiratory end fitting 150 of the pneumatic system 105.

Each first and second connecting structure 195, 200 of the dual connector apparatus 190 can include an annular ring 210, 215 of similar dimension to the annular grooves 180, 185 of the end fittings 170, 175 of the first and second branch tubes 125, 130 of the pneumatic connector device 100. The annular rings 210, 215 can be capable of being slid onto and advanced over a tapered construction at the end fittings 170, 175 of the branch tubes 125, 130 until the annular rings firmly slip into or snap into proper positive attachment in the annular grooves 180, 185 of the end fittings 170, 175 of the manifold 120 of the pneumatic connector device 100. Once the annular rings 210, 215 of the connecting structures 195, 200 positively attach into the annular grooves 180, 185 of the end fittings 170, 175 of the manifold 120, the dual connector 190 can be positively locked to the end fittings 170, 175 of the manifold 120 and attached breathing circuit tube 110 leading to the patient interface 115, and cannot be removed without substantial force.

Each connecting structure 195, 200 of the dual connector apparatus 190 can further include a flexible jaw or latch 225, 230 configured to positively attach at the respective end fitting 145, 150 of the pneumatic system 105. Each flexible latch 225, 230 can include a semi-annular catch or step 245 (See FIG. 3) to engage against the reduced diameter portion 155 or shoulder 160 of the end fittings 145, 150. An embodiment of the first and second latches 225, 230 can each include a step or protrusion 245 that engages against the reduced diameter portion 155 or shoulder 160 of the end fittings 145, 150 of the pneumatic system 105.

An embodiment of the latches 225, 230 of the first and second connecting structures 195, 200 can be connected by pairs of first and second flexible bridge tabs 235, 240 (See FIG. 2) to the annular rings 210, 215. An embodiment of the first connecting structure 195 includes a first pair of bridge tabs 235 that interconnect the first latch 225 to the first annular ring 210. In a similar manner, the second connecting structure 200 includes a second pair of bridge tabs 240 that interconnects the second latch 230 to the second annular ring 215. Each first and second pair of bridge tabs 235 define a gap 250 (See FIG. 2) therebetween, such that the first pair of bridge tabs 235 separate the first latch 225 from the first annular ring 210, and the second pair of bridge tabs 240 separate the second latch 230 from the second annular ring 215. The number of bridge tabs 235, 240 can vary. The pairs of bridge tabs 235, 240 can interconnect between an edge 260 of the first and second latches 225, 230 (opposite the step or protrusion 245) and the annular rings 210, 215 respectively.

An embodiment of the pull arm 205 can include a first end that connects at the edge 260 of the first latch 225, and a second end that interconnect to the second latch 230 in a similar manner, both opposite the step or protrusion 245. A substantial length of the pull arm 205 between the first and second ends can be substantially linear aligned along its length. The pull arm 205 can also include an actuator handle 265. The illustrated example of the actuator handle 265 can be ring-shaped of standard dimension to receive a operator finger, and located along the substantial linear length of the pull arm 205. Yet the shape of the actuator handle 265 can vary. The length of the pull arm 205 can be of standard dimension according to the space between the expiratory branch tube 125 relative to the inspiratory branch tube 130 of the manifold 120 to receive the end fittings 145, 150 at the pneumatic system 105.

Having described the general construction of the pneumatic connector device 100 having the dual connector apparatus 190, the following is a general description of the operation of the pneumatic connector device 100 in positively attaching the pair of end fittings 170, 175 of the pneumatic connector manifold 120 to the end fittings 145, 150 at the pneumatic system 105. It should be understood that the following description of the operation of the pneumatic connector device 100 may include more steps or less steps and may not be all-inclusive.

Assume for sake of example that the annular rings 210, 215 of the dual connector apparatus 190 of the pneumatic connector device 100 are both positively engaged thereby locked in the annular grooves 180, 185 in the expiratory and inspiratory end fittings 170, 175 of the manifold 120, as described above. Both expiratory and inspiratory branch tubes 125, 130 of the manifold 120 are ready to positively attach via the dual connector apparatus 190 to the end fittings 145, 150 of the pneumatic system 105.

An embodiment of the dual connector 190 can be operatively configured to generally simultaneously attach the end fittings 170, 175 expiratory and inspiratory branch tubes 125, 130 of the pneumatic manifold 120 to the respective end fittings 145, 150 of the pneumatic system 105. With pressure applied to advance the female type end fittings 170, 175 of the manifold 120 over the respective male type end fittings 145, 150 of the pneumatic system 105, each latch 225, 230 can be configured to angularly deflect or displace away relative to the angular rings 210, 215.

As the annular latches 225, 230 advance beyond the enlarged diameter portion 160 and over the reduced diameter portion 155 of the end fittings 145, 150, the annular latches 225, 230 deflects or displaces under material memory bias into engagement against the reduced diameter portion 155 or the shoulder 165 defined between the reduced and enlarged diameter portions 155, 160, respectively. According to one embodiment, an audible click can be heard when the annular latches 225, 230 snaps into engagement with the reduced diameter portion 155 or shoulder 165, the click giving affirmation of the proper attachment of the pneumatic connector device 100 to the end fittings 145, 150 of the pneumatic system 105. The engagement of the annular latches 225, 230 of the dual connector apparatus 190 against the shoulder 165 of the end fittings 145, 150 can positively attach or lock the end fittings 170, 175 of the manifold 120 of the pneumatic connector device 100 in proper attachment to the end fittings 145, 150 at the pneumatic system 105.

The dual connector apparatus 190 can also provide for ready and generally simultaneous detachment or removal of both end fittings 170, 175 of the manifold 120 of the pneumatic connector device 100 from the end fittings 145, 150 at the pneumatic system 105 with a same, single application force (illustrated by arrow and reference 270) at the pull arm 205 of the dual connector apparatus 190. The single application of force 270 at the actuator handle 265 of the pull arm 205 can bias both annular latches 195, 200 from engagement against the reduced diameter portion 155 of the end fittings 145, 150. The pull arm 205 can be operable to generally transmit the application force amongst the pairs of tab bridges 235, 240 at the connecting structures 195, 200, causing a bending moment or bias about the pairs of bridge tabs 235, 240 to deflect or displace or both annular latches 225, 230 away from engagement against the end fittings 145, 150 at the pneumatic system 105. The dual connector apparatus 190 can transmit the application force as a generally inward bending moment force to both connecting structures 195, 200 to cause angular displacement or deflection with respect to the annular rings 210, 215 in a generally simultaneous manner, releasing both annular latches 225, 230 in a generally simultaneous manner from engagement against the reduced diameter portion 155 or shoulder 165 of the end fittings 145, 150.

With release of engagement of the annular latches 225, 230, the dual connector apparatus 190 and connected manifold 120 of the pneumatic connector device 100 are released in a generally simultaneous manner from positive attachment to the end fittings 145, 150 of the pneumatic system 105. To cause this generally simultaneous release of the both end fittings 170, 175 of the manifold 120 from positive attachment to the end fittings 145, 150, the actuator handle 265 can be generally operable to transmit the application force 270 to create the bending moment to deflect both annular latches 225, 230 in the general simultaneous manner from engagement against end fittings 145, 150 so as to release the pneumatic connector device 100 from the end fittings 145, 150. Of course, actuator handle 265 can be a general bend (e.g., curve, etc. or other shape) to guide location to apply the application force 270 to the dual connector apparatus 190, and its shape is not limiting. Furthermore, although the dual connector apparatus 190 can be described to include the actuator handle 265, the actuator handle 265 may not be included, and an operator can apply the application at any point along the pull arm 205 to generally cause the bias force to deflect both annular latches 225, 230 from engagement against the end fittings 145, 150 in a sufficient manner to operate the dual connector apparatus 190 in releasing the manifold 120 of the pneumatic connector device 100 from the end fittings 145, 150 of the pneumatic system 105.

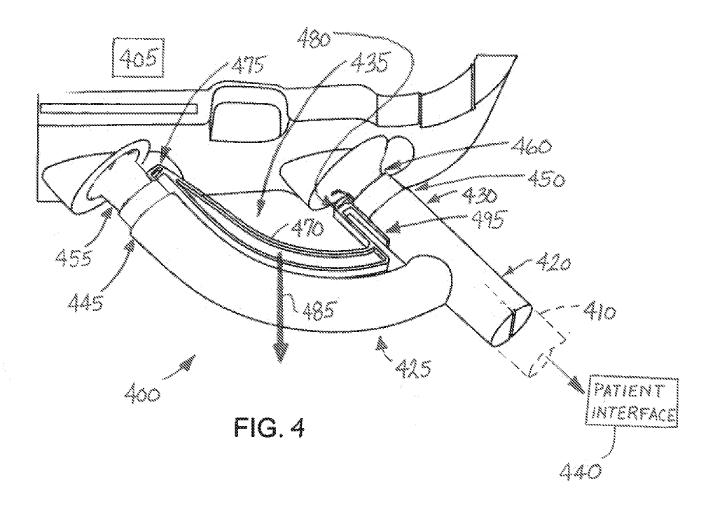

FIG. 4 shows another embodiment of a pneumatic connector device 400 configured to connect to pneumatic system 405 to a single pneumatic circuit tube or hose 410, the pneumatic system 405 and pneumatic circuit tube 410 of similar construction to the pneumatic system 105 and pneumatic circuit tube 110 described above. The pneumatic connector device 400 can include a manifold 420 having a first branch tube 425 and an second branch tube 430 integrally constructed as part of a dual connector apparatus 435. An example of the first branch tube 425 can be associated with transmitting expiratory fluids with the pneumatic circuit tube 410 leading to a patient interface 440, and the second branch tube 430 can be associated with transmitting inspiratory fluids with the pneumatic circuit tube 410 leading to the patient interface 440. Each expiratory and inspiratory branch tubes 425, 430 of the manifold 420 can include a female type connecting structures 445, 450 (similar to the connecting structures 170, 175) to receive the male type end fittings 455, 460 of the pneumatic system 405. A pull arm 470 generally extends between and connects to a deflectable latches 475, 480 located at each opposite connecting structures 445, 450 of the pneumatic connector device 400. The exemplary pull arm 470 is curvilinear shaped, but the shape (e.g., linear, angular, etc.) can vary. Each latch 475, 480 can be configured to engage against the end fittings 455, 460 in a similar fashion as described above with respect to the above-described embodiment of the pneumatic connector device 100. In a like a manner, an application force 485 can be applied along the length of the pull atm 470 can create a bending moment or bias force about a first and second pairs of bridge tabs 495 attached at the manifold 420, so to cause each first and second latch 475, 480 to deflect away from and release engagement with the end fittings 455, 460 of the pneumatic system 405 so as to release the pneumatic connector device 400 and attached pneumatic circuit tube 410 from attachment at the end fittings 455, 460 of the pneumatic system 405.

Although the above description of the embodiments of the pneumatic connector devices 100 and 400 are described with reference to attachment of a pneumatic circuit tube between a patient interface and a pneumatic system, the device 100 and method of operation may not so limited. The device 100 and method of operation can be employed in other applications of attaching medical hoses to medical machines, and furthermore can be applied to other industrial applications to connect hoses to a machine.

A technical effect of the embodiments of the pneumatic connector device 100, 400 described herein includes provides for attachment of multiple medical hoses to a medical machine (e.g., pneumatic or ventilation system). In one example, an advantage of the pneumatic connector device 100, 400 and dual connector 190 provides for a need for ready connection and disconnection of the pneumatic circuit tube 110, 410 between the patient interface 115, 440 and the pneumatic system 105, 405. The pneumatic connector device 100, 400 can be inexpensive, compatible with industry standards, and provide a reliable positive connection and ready disconnection of medical devices, tubes or hoses (e.g., manifold 120, 420 and pneumatic circuit tube 110, 410 and interface 115, 440) for cleaning or disposal. The pneumatic connector device 100, 400 can prevent unintended or undesired misconnections because the connecting structures can be located at a fixed distance in accordance to industry standards to receive the end fittings at the pneumatic system 105, 405.

In another example of a technical effect, the pneumatic connector device 100, 400 can prevent a force (whether intentional or unintentional such as tripping over circuit tube 110, 420) exerted at the pneumatic circuit tube 110, 410 or interface 115, 440 from causing disconnection of the pneumatic circuit tube 110 from connection at the pneumatic system 105. The pneumatic connector device 100, 400 can prevent disconnections because retention of the pneumatic circuit tube 110, 410 at the pneumatic system 105, 405 can be provided with a positive interference of the latches 225, 230, 475, 480 at the end fittings 145, 150, 455, 460 rather than sliding interference between the expiratory and inspiratory tube end fittings 170, 175 or connecting structures 445, 450 in relation to the end fittings 145, 150, 455, 460 of the pneumatic system 105, 405. The pneumatic connector device 100, 400 also provides operator feedback by generating an audible click with proper positive attachment of the latches 225, 230, 475, 480 of the pneumatic connector devices 100, 400 to the end fittings 145, 150, 455, 460 of the pneumatic systems 105, 405. An application of force at multiple points or discrete areas along the length of the pull arm 205, 470 of the connector devices 100, 400 can cause release of the latches 225, 230, 475, 480 and disconnection from the pneumatic system 105, 405, but the connector devices 100, 400 can otherwise prevent disconnection if the application of force is exerted on the manifold 120, 420, pneumatic tube or hose 110, 410 or at the interface 115, 440. An application of force at multiple discrete areas (e.g., manifold, 420 or branch tubes 425, 430) of the connector device 400 can cause general simultaneous connection of the both end connecting structures 175, 180, 445, 450; latches 225, 230, 475, 480; and attached pneumatic circuit tube 110, 410 and interface 115, 440 to the end fittings 455, 460 of the pneumatic system 405.

It should be understood that one or more constructive aspects or features (e.g., connecting structure 195, 200, manifolds 120, latches 225, 230, pull arm 205, etc.) described above for the illustrated embodiments of the connector device 100 can be incorporated on the illustrated embodiments of the connector device 400, and vice versa, and is not limiting on the subject matter described herein.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A connector device to attach a pneumatic circuit tube to a first and second end fitting of a pneumatic system, the device comprising:
a first connecting structure that positively attaches the pneumatic circuit tube to the first end fitting of the pneumatic system;
a second connecting structure that positively attaches the pneumatic circuit tube to the second end fitting of the pneumatic system; and
a pull arm that connects between the first connecting structure to the second connecting structure, wherein the pull arm transmits a single application of force on the pull arm to release both the first connecting structure from attachment at the first end fitting and the second connecting structure from attachment at the second end fitting.

2. The connector device of claim 1, wherein the first connecting structure includes a first latch that positively attaches the pneumatic circuit tube to the first end fitting of the pneumatic system, wherein the second connecting structure includes a second latch that positively attaches the pneumatic circuit tube to the second end fitting of the pneumatic system and wherein the pull arm transmits the application of force to create a bending moment at each connecting structure to release both the first connecting structure from attachment at the first end fitting and the second connecting structure from attachment at the second end fitting.

3. The connector device of claim 2, wherein the first connecting structure includes a first annular ring that positively attaches the first connecting structure to the pneumatic circuit tube, and the second connecting structure includes a second annular ring that positively attaches the second connecting structure to the pneumatic circuit tube.

4. The connector device of claim 3, wherein there is a gap between each of: the first latch relative to the first annular ring and between the second latch and the second annular ring.

5. The connector device of claim 3, wherein the first connecting structure includes a bridge tab that connects the first latch to the first annular ring, and a second bridge tab that connects the second latch to the second annular ring.

6. The connector device of claim 3, wherein the pull arm transmits the application force to create a bending moment about each bridge tab to deflect and release the first and second latches from the first and second end fittings of the pneumatic system.

7. The connector device of claim 3, wherein the first and second latches deflect with respect to the first and second annular rings, respectively.

8. The connector device of claim 3, wherein the first connecting structure includes the first pair of bridge tabs, wherein the first pair of bridge tabs define a gap therebetween, the gap separating the first latch from the first annular ring.

9. The connector device of claim 2, wherein the application force at the pull arm causes both release of the first latch from the first end fitting generally simultaneous with release of the second latch from the second end fitting.

10. The connector device of claim 1, further including an actuator handle located along a length of the pull arm, wherein the actuator handle receives the application force.

11. The connector device of claim 10, wherein the actuator handle includes a ring shaped structure attached in general perpendicular alignment to the substantial length of the pull arm.

12. The connector device of claim 1, wherein the first connecting structure is not aligned with the second connecting structure.

13. The connector device of claim 1, wherein the connector device is of a plastic composition and of an integral construction.

14. The connector device of claim 1, wherein the first connecting structure is in general alignment with the second connecting structure.

15. The connector device of claim 1, further comprising a pneumatic manifold connecting the pneumatic circuit tube to the first end fitting at the pneumatic system, the pneumatic manifold including a first branch tube connecting to the first end fitting of the pneumatic system and a second branch tube connecting to the second end fitting of the pneumatic system.

16. The connector device of claim 15, wherein the first connecting structure attaches the first branch tube at the first end fitting of the pneumatic system and the second connecting structure attaches the second branch tube to the second end fitting of the pneumatic system.

17. A connector device to connect a pneumatic circuit tube between a patient interface and a pneumatic system, the device comprising:
a manifold including a first tube and second tube that interconnects the pneumatic circuit tube to the first and second end fittings of the pneumatic system; and
a dual connector apparatus that includes a first connecting structure and a second connecting structure, the first connecting structure that positively attaches the first tube at the first end fitting of the pneumatic system and the second connecting structure that positively attaches the second tube at the second end fitting, the dual connector further including a pull arm that interconnects the first and second connecting structures, wherein an application of force on the pull arm causes both release of the first and second connecting structures from positive attachment at the first and second end fittings of the pneumatic system.

18. The connector device of claim 17, wherein the first connecting structure includes a first latch that positively attaches the first tube to the first end fitting of the pneumatic system, and wherein the second connecting structure includes a second latch that positively attaches the second tube to the second end fitting of the pneumatic system.

19. The connector device of claim 17, wherein dual connector apparatus is integrally constructed with the manifold.

20. The connector device of claim 17, wherein dual connector apparatus is removable with respect to construction of the manifold.
